(19) United States
(12) Patent Application Publication
(10) Pub. No.: US 2025/0220740 A1
(43) Pub. Date: Jul. 3, 2025

(54) INFORMATION PROCESSING METHOD, APPARATUS, USER TERMINAL AND STORAGE MEDIUM

(71) Applicant: DATANG MOBILE COMMUNICATIONS EQUIPMENT CO.,LTD., Beijing (CN)

(72) Inventor: Yali ZHAO, Beijing (CN)

(21) Appl. No.: 18/853,146

(22) PCT Filed: Mar. 27, 2023
(86) PCT No.: PCT/CN2023/084178

§ 371 Date: Oct. 1, 2024

(30) Foreign Application Priority Data
Apr. 22, 2022 (CN) 202210429709.8

(51) Int. Cl. H04W 76/14; H04L 69/22; H04W 76/11; H04W 88/04

(52) U.S. Cl. CPC H04W 76/14; H04L 69/22; H04W 76/11; H04W 88/04

(57) ABSTRACT

The present disclosure provides an information processing method, an apparatus, a user terminal and a storage medium. A relay user terminal or a remote user terminal acquires a first identification used by a first remote user terminal and a second remote user terminal at a direct communication interface; determines a mapping relationship between the first identification and a second identification; sends the mapping relationship to the first remote user terminal and/or the second remote user terminal. Through this scheme, as the number of bits of the second identification is less than that of the first identification, in a process of end-to-end communication, when the second identification is carried in an adaptation layer, a head overhead of the adaptation layer can be saved, to improve a resource utilization rate when the remote user terminal performs data transmission through the relay user terminal and ensuring an end-to-end data transmission efficiency.

### CROSS-REFERENCE TO RELATED APPLICATIONS

The present disclosure is a National Stage of International Application No. PCT/CN2023/084178, filed on Mar. 27, 2023, which claims priority to Chinese Patent Application No. 202210429709.8, titled “INFORMATION PROCESSING METHOD, APPARATUS, TERMINAL AND STORAGE MEDIUM”, filed to China National Intellectual Property Administration on Apr. 22, 2022. The two applications are hereby incorporated by reference in their entireties.

### FIELD

The present disclosure relates to the field of communication and, in particular, to an information processing method, an apparatus, a user terminal and a storage medium.

### BACKGROUND

In order to expand the network coverage in the 5^{th} generation (5G) NR (New Radio, New Radio) system, a relay from a user terminal, which may be a user equipment (UE), to a network device (UE-to-Network Relay, U2N Relay) and a relay from a user terminal to a user terminal (UE-to-UE Relay, U2U Relay) are introduced. For the U2N Relay, a remote user terminal can access a network device through the U2N relay; and for the U2U Relay, the remote user terminal can access a target user terminal through the U2U Relay.

In the related technology, when the remote user terminal performs an end-to-end communication through a relay user terminal, an identification of a bearer interface needs to be configured by an adaptation layer of the relay user terminal. However, these identifications will lead to a large header overhead of the adaptation layer, resulting in a low resource utilization rate in the end-to-end communication process.

### SUMMARY

The present application provides an information processing method, an apparatus, a user terminal and a storage medium, which are used for reducing a header overhead of an adaptation layer and ensuring a data transmission efficiency of an end-to-end communication.

One embodiment of the present disclosure provides an information processing method, which is applied to a relay user terminal, the information processing method includes: acquiring a first identification used by a first remote user terminal and a second remote user terminal at a direct communication interface, where the first remote user terminal and the second remote user terminal are in end-to-end communication connection through the relay user terminal; determining a mapping relationship between the first identification and a second identification; and sending the mapping relationship to the first remote user terminal and/or the second remote user terminal; where the first identification includes a source L2 identity and a destination L2 identity used by the direct communication interface, or the first identification includes the source L2 identity, the destination L2 identity and a transmission type, and the number of bits of the second identification is less than that of the first identification.

In some embodiments, the acquiring the first identification used by the first remote user terminal and the second remote user terminal at the direct communication interface includes: receiving the first identification sent by the first remote user terminal and/or the second remote user terminal; or acquiring, by a lower layer of the relay user terminal, the first identification from an upper layer of the relay user terminal.

In some embodiments, the receiving the first identification sent by the first remote user terminal and/or the second remote user terminal includes: receiving the first identification sent by the first remote user terminal through a first direct communication interface radio resource control (PC5-RRC) signaling; and/or receiving the first identification sent by the second remote user terminal through a second PC5-RRC signaling.

In some embodiments, the acquiring, by the lower layer of the relay user terminal, the first identification from the upper layer of the relay user terminal includes: acquiring, by the upper layer of the relay user terminal, the first identification through a ProSe communication-signalling (PC5-S) signaling process, and sending first indication information carrying the first identification to the lower layer of the relay user terminal, and the lower layer of the relay user terminal acquires the first identification through the first indication information.

In some embodiments, the determining the mapping relationship between the first identification and the second identification includes: receiving second indication information sent by the first remote user terminal and/or the second remote user terminal, and determining the mapping relationship between the first identification and the second identification according to the second indication information; or determining the mapping relationship between the first identification and the second identification according to the first identification and a currently available second identification of the relay user terminal.

In some embodiments, he determining the mapping relationship between the first identification and the second identification according to the first identification and the currently available second identification of the relay user terminal includes: determining a currently unoccupied candidate second identification as the currently available second identification of the relay user terminal; and for the first identification, selecting the second identification from the currently available second identification of the relay user terminal; and determining the mapping relationship between the first identification and the second identification according to the second identification.

In some embodiments, the sending the mapping relationship between the first identification and the second identification to the first remote user terminal and/or the second remote user terminal includes: sending the mapping relationship to the first remote user terminal through a first PC5-RRC signaling between the relay user terminal and the first remote user terminal; and/or sending the mapping relationship to the second remote user terminal through a second PC5-RRC signaling between the relay user terminal and the second remote user terminal.

In some embodiments, when the relay user terminal performs data transmission with the first remote user terminal through the direct communication interface, the second identification is carried in a protocol data unit (PDU) header of an adaptation layer: and/or when the relay user terminal performs data transmission with the second remote user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal: or a logical channel identification LCID of the end-to-end direct communication interface between the first remote user terminal and the second remote user terminal.

One embodiment of the present disclosure provides an information processing method, applied to a first remote user terminal or a second remote user terminal, where the first remote user terminal is in end-to-end communication connection with the second remote user terminal through a relay user terminal, the information processing method includes: acquiring a mapping relationship between a first identification and a second identification; determining a PDU header format of an adaptation layer according to the mapping relationship: where the first identification includes a source L2 identity and a destination L2 identity used by a direct communication interface, or the first identification includes the source L2 identity, the destination L2 identity and a transmission type, and the number of bits of the second identification is less than that of the first identification.

In some embodiments, the acquiring the mapping relationship between the first identification and the second identification includes: receiving the mapping relationship sent by the relay user terminal: or determining the mapping relationship according to the first identification and the second identification.

In some embodiments, the receiving the mapping relationship sent by the relay user terminal includes: acquiring the first identification: sending second indication information and the first identification to the relay user terminal through a first PC5-RRC signaling between the first remote user terminal and the relay user terminal, and receiving the mapping relationship sent by the relay user terminal through the first PC5-RRC signaling;

and/or sending the second indication information and the first identification to the relay user terminal through a second PC5-RRC signaling between the second remote user terminal and the relay user terminal, and receiving the mapping relationship sent by the relay user terminal through the second PC5-RRC signaling.

In some embodiments, the determining the mapping relationship according to the first identification and the second identification includes: acquiring the first identification; and determining a currently unoccupied candidate second identification as a currently available second identification of the relay user terminal; and for the first identification, selecting the second identification from the currently available second identification of the relay user terminal; determining the mapping relationship between the first identification and the second identification according to the second identification.

In some embodiments, the acquiring the first identification includes: acquiring, by an upper layer of the first remote user terminal, the first identification through a PC5-S signaling process, and sending third indication information carrying the first identification to a lower layer of the first remote user terminal, and the lower layer of the first remote user terminal acquires the first identification through the third indication information; or acquiring the first identification through an end-to-end PC5-RRC signaling interaction process performed by the lower layer of the first remote user terminal.

In some embodiments, the information processing method further includes at least one of the following operations: sending, by the first remote user terminal, the mapping relationship to the relay user terminal through a first PC5-RRC signaling; or sending, by the second remote user terminal, the mapping relationship to the relay user terminal through a second PC5-RRC signaling; or sending, by the first remote user terminal, the mapping relationship to the second remote user terminal through an end-to-end third PC5-RRC signaling between the first remote user terminal and the second remote user terminal; or sending, by the second remote user terminal, the mapping relationship to the first remote user terminal through the third PC5-RRC signaling.

In some embodiments, when the first remote user terminal performs data transmission through the direct communication interface, the second identification is carried in a PDU header of an adaptation layer; and/or when the second remote user terminal performs data transmission with the relay user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal; or a logical channel identification LCID of the end-to-end direct communication interface between the first remote user terminal and the second remote user terminal.

One embodiment of the present disclosure provides a relay user terminal, including: an acquisition module, configured to acquire a first identification used by a first remote user terminal and a second remote user terminal at a direct communication interface, where the first remote user terminal and the second remote user terminal are in end-to-end communication connection through the relay user terminal; a determining module, configured to determine a mapping relationship between the first identification and a second identification; and a sending module, configured to send the mapping relationship to the first remote user terminal and/or the second remote user terminal; where the first identification includes a source L2 identity and a destination L2 identity used by the direct communication interface, or the first identification includes the source L2 identity, the destination L2 identity and a transmission type, and the number of bits of the second identification is less than that of the first identification.

In some embodiments, the acquisition module is configured to: receive the first identification sent by the first remote user terminal and/or the second remote user terminal; or acquire, by a lower layer of the relay user terminal, the first identification from an upper layer of the relay user terminal.

In some embodiments, the acquisition module is configured to: receive the first identification sent by the first remote user terminal through a first PC5-RRC signaling; and/or receive the first identification sent by the second remote user terminal through a second PC5-RRC signaling.

In some embodiments, the acquisition module is configured for the upper layer of the relay user terminal to acquire the first identification through a PC5-S signaling process, and send first indication information carrying the first identification to the lower layer of the relay user terminal, and the lower layer of the relay user terminal acquires the first identification through the first indication information.

In some embodiments, the acquisition module is configured to: receive second indication information sent by the first remote user terminal and/or the second remote user terminal, and determine the mapping relationship between the first identification and the second identification according to the second indication information; or determine the mapping relationship between the first identification and the second identification according to the first identification and a currently available second identification of the relay user terminal.

In some embodiments, the acquisition module is configured to: determine a currently unoccupied candidate second identification as the currently available second identification of the relay user terminal; and for the first identification, select the second identification from the currently available second identification of the relay user terminal; and determine the mapping relationship between the first identification and the second identification according to the second identification.

In some embodiments, the sending module is configured to: send the mapping relationship to the first remote user terminal through a first PC5-RRC signaling between the relay user terminal and the first remote user terminal; and/or send the mapping relationship to the second remote user terminal through a second PC5-RRC signaling between the relay user terminal and the second remote user terminal.

In some embodiments, when the relay user terminal performs data transmission with the first remote user terminal through the direct communication interface, the second identification is carried in a PDU header of an adaptation layer; and/or when the relay user terminal performs data transmission with the second remote user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal; or a logical channel identification LCID of the end-to-end direct communication interface between the first remote user terminal and the second remote user terminal.

One embodiment of the present disclosure provides a remote user terminal, where the remote user terminal is a first remote user terminal or a second remote user terminal, and the first remote user terminal and the second remote user terminal are in end-to-end communication connection through a relay user terminal, the remote user terminal includes: an acquisition module, configured to acquire a mapping relationship between a first identification and a second identification; and a determining module, configured to determine a PDU header format of an adaptation layer according to the mapping relationship; where the first identification includes a source L2 identity and a destination L2 identity used by a direct communication interface, or the first identification includes the source L2 identity, the destination L2 identity and a transmission type, and the number of bits of the second identification is less than that of the first identification.

In some embodiments, the acquisition module is configured to: receive the mapping relationship sent by the relay user terminal; or determine the mapping relationship according to the first identification and the second identification.

In some embodiments, the acquisition module is configured to: acquire the first identification: send second indication information and the first identification to the relay user terminal through a first PC5-RRC signaling between the first remote user terminal and the relay user terminal, and receive the mapping relationship sent by the relay user terminal through the first PC5-RRC signaling; and/or send the second indication information and the first identification to the relay user terminal through a second PC5-RRC signaling between the second remote user terminal and the relay user terminal, and receive the mapping relationship sent by the relay user terminal through the second PC5-RRC signaling.

In some embodiments, the acquisition module is configured to: acquire the first identification; determine the currently unoccupied candidate second identification as a currently available second identification of the relay user terminal; and for the first identification, select the second identification from the currently available second identification of the relay user terminal; and determine the mapping relationship between the first identification and the second identification according to the second identification.

In some embodiments, the acquisition module is configured for an upper layer of the first remote user terminal to acquire the first identification through a PC5-S signaling process, and send third indication information carrying the first identification to a lower layer of the first remote user terminal, and the lower layer of the first remote user terminal acquires the first identification through the third indication information; or acquire the first identification through an end-to-end PC5-RRC signaling interaction process performed by the lower layer of the first remote user terminal.

In some embodiments, the remote user terminal further includes a sending module, configured for the first remote user terminal to send the mapping relationship to the relay user terminal through a first PC5-RRC signaling; or configured for the second remote user terminal to send the mapping relationship to the relay user terminal through a second PC5-RRC signaling; or configured for the first remote user terminal to send the mapping relationship to the second remote user terminal through an end-to-end third PC5-RRC signaling between the first remote user terminal and the second remote user terminal; or configured for the second remote user terminal to send the mapping relationship to the first remote user terminal through the third PC5-RRC signaling.

In some embodiments, where when the first remote user terminal performs data transmission through the direct communication interface, the second identification is carried in a PDU header of an adaptation layer; and/or when the second remote user terminal performs data transmission with the relay user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal; or a logical channel identification LCID of the end-to-end direct communication interface between the first remote user terminal and the second remote user terminal.

One embodiment of the present disclosure provides a relay user terminal, including:
a memory, configured to store a computer program;
a transceiver, configured to receive and send data under control of a processor;
the processor, configured to read the computer program in the memory and perform the following operations: acquiring a first identification used by a first remote user terminal and a second remote user terminal at a direct communication interface, where the first remote user terminal and the second remote user terminal are in end-to-end communication connection through the relay user terminal; determining a mapping relationship between the first identification and a second identification; and sending the mapping relationship to the first remote user terminal and/or the second remote user terminal; where the first identification includes a source L2 identity and a destination L2 identity used by the direct communication interface, or the first identification includes the source L2 identity, the destination L2 identity and a transmission type, and the number of bits of the second identification is less than that of the first identification.

In some embodiments, the processor is further configured to perform at least one of the following operations: receiving the first identification sent by the first remote user terminal and/or the second remote user terminal: or acquiring, by a lower layer of the relay user terminal, the first identification from an upper layer of the relay user terminal.

In some embodiments, the processor is further configured to perform the following operations: receiving the first identification sent by the first remote user terminal through a first PC5-RRC signaling; and/or receiving the first identification sent by the second remote user terminal through a second PC5-RRC signaling.

In some embodiments, the processor is further configured to perform the following operations: acquiring, by the upper layer of the relay user terminal, the first identification through a PC5-S signaling process, and sending first indication information carrying the first identification to the lower layer of the relay user terminal, and the lower layer of the relay user terminal acquires the first identification through the first indication information.

In some embodiments, the processor is further configured to perform at least one of the following operations: receiving second indication information sent by the first remote user terminal and/or the second remote user terminal, and determining the mapping relationship between the first identification and the second identification according to the second indication information; or determining the mapping relationship between the first identification and the second identification according to the first identification and a currently available second identification of the relay user terminal.

In some embodiments, the processor is further configured to perform the following operations: determining a currently unoccupied candidate second identification as the currently available second identification of the relay user terminal; and for the first identification, selecting the second identification from the currently available second identification of the relay user terminal; and determining the mapping relationship between the first identification and the second identification according to the second identification.

In some embodiments, the processor is further configured to perform the following operations: sending the mapping relationship to the first remote user terminal through a first PC5-RRC signaling between the relay user terminal and the first remote user terminal; and/or sending the mapping relationship to the second remote user terminal through a second PC5-RRC signaling between the relay user terminal and the second remote user terminal.

In some embodiments, when the relay user terminal performs data transmission with the first remote user terminal through the direct communication interface, the second identification is carried in a protocol data unit PDU header of an adaptation layer; and/or when the relay user terminal performs data transmission with the second remote user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal; or a logical channel identification LCID of the end-to-end direct communication interface between the first remote user terminal and the second remote user terminal.

One embodiment of the present disclosure provides a remote user terminal, where the remote user terminal is a first remote user terminal or a second remote user terminal, and the first remote user terminal is in end-to-end communication connection with the second remote user terminal through a relay user terminal, the remote user terminal includes:
a memory, configured to store a computer program;
a transceiver, configured to receive and send data under control of a processor;
the processor, configured to read the computer program in the memory and perform the following operations: acquiring a mapping relationship between a first identification and a second identification; determining a PDU header format of an adaptation layer according to the mapping relationship; where the first identification includes a source L2 identity and a destination L2 identity used by a direct communication interface, or the first identification includes the source L2 identity, the destination L2 identity and a transmission type, and the number of bits of the second identification is less than that of the first identification.

In some embodiments, the processor is further configured to perform at least one of the following operations: receiving the mapping relationship sent by the relay user terminal; or determining the mapping relationship according to the first identification and the second identification.

In some embodiments, the processor is further configured to perform the following operations: acquiring the first identification; and sending second indication information and the first identification to the relay user terminal through a first PC5-RRC signaling between the first remote user terminal and the relay user terminal, and receiving the mapping relationship sent by the relay user terminal through the first PC5-RRC signaling; and/or sending the second indication information and the first identification to the relay user terminal through a second PC5-RRC signaling between the second remote user terminal and the relay user terminal, and receiving the mapping relationship sent by the relay user terminal through the second PC5-RRC signaling.

In some embodiments, the processor is further configured to perform the following operations: acquiring the first identification; determining a currently unoccupied candidate second identification as a currently available second identification of the relay user terminal; for the first identification, selecting the second identification from the currently available second identification of the relay user terminal; and determining the mapping relationship between the first identification and the second identification according to the second identification.

In some embodiments, the processor is further configured to perform at least one of the following operations: acquiring, by an upper layer of the first remote user terminal, the first identification through a PC5-S signaling process, and sending third indication information carrying the first identification to a lower layer of the first remote user terminal, and the lower layer of the first remote user terminal acquires the first identification through the third indication information; or acquiring the first identification through an end-to-end PC5-RRC signaling interaction process performed by the lower layer of the first remote user terminal.

In some embodiments, the processor is further configured to perform at least one of the following operations: sending, by the first remote user terminal, the mapping relationship to the relay user terminal through a first PC5-RRC signaling; or sending, by the second remote user terminal, the mapping relationship to the relay user terminal through a second PC5-RRC signaling; or sending, by the first remote user terminal, the mapping relationship to the second remote user terminal through an end-to-end third PC5-RRC signaling between the first remote user terminal and the second remote user terminal; or sending, by the second remote user terminal, the mapping relationship to the first remote user terminal through the third PC5-RRC signaling.

In some embodiments, when the first remote user terminal performs data transmission through the direct communication interface, the second identification is carried in a PDU header of an adaptation layer; and/or when the second remote user terminal performs data transmission with the relay user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal; or a logical channel identification LCID of the end-to-end direct communication interface between the first remote user terminal and the second remote user terminal.

One embodiment of the present disclosure provides a processor-readable storage medium, where the processor-readable storage medium stores a computer program for causing a processor to execute the information processing method as in any one of the embodiments.

One embodiment of the present disclosure provides a computer program product, including a computer program which, when executed by a processor, realizes the information processing method as in any one of the embodiments.

The present disclosure provides an information processing method, an apparatus, a user terminal and a storage medium. A relay user terminal or a remote user terminal acquires a first identification used by a first remote user terminal and a second remote user terminal at a direct communication interface, where the first remote user terminal and the second remote user terminal are in end-to-end communication connection through the relay user terminal; determine a mapping relationship between the first identification and a second identification; and sends the mapping relationship to the first remote user terminal and/or the second remote user terminal. Through this scheme, as the number of bits of the second identification is less than that of the first identification, in a process of end-to-end communication, when the second identification is carried in an adaptation layer, a head overhead of the adaptation layer can be saved, to improve a resource utilization rate when the remote user terminal performs data transmission through the relay user terminal.

It should be understood that what is described in the above summary section is not intended to define key or important features of the embodiments of the present disclosure, nor is it intended to limit the scope of the present disclosure. Other features of the present disclosure will be readily understood from the following description.

### BRIEF DESCRIPTION OF DRAWINGS

FIG. 1 is a schematic diagram of an application scenario provided by an embodiment of the present disclosure.

FIG. 2 is a first schematic diagram for signaling interaction of an information processing method provided by an embodiment of the present disclosure.

FIG. 3a is a first schematic diagram of a PDU header of an adaptation layer provided by an embodiment of the present disclosure.

FIG. 3b is a second schematic diagram of a PDU header of an adaptation layer provided by an embodiment of the present disclosure.

FIG. 4 is a second schematic diagram for signaling interaction of an information processing method provided by an embodiment of the present disclosure.

FIG. 5 is a third schematic diagram for signaling interaction of an information processing method provided by an embodiment of the present disclosure.

FIG. 6 is a fourth schematic diagram for signaling interaction of an information processing method provided by an embodiment of the present disclosure.

FIG. 7 is a first structural schematic diagram of a relay user terminal provided by an embodiment of the present disclosure.

FIG. 8 is a first structural diagram of a remote user terminal provided by an embodiment of the present disclosure.

FIG. 9 is a second structural schematic diagram of a relay user terminal provided by an embodiment of the present disclosure.

FIG. 10 is a second structural schematic diagram of a remote user terminal provided by an embodiment of the present disclosure.

### DESCRIPTION OF EMBODIMENTS

In this disclosure, the term “and/or” describes a relationship of related objects, indicating that there can be three kinds of relationships, for example, A and/or B would mean that A exists alone, A and B exist at the same time, and B exists alone. The character “/” generally indicates that the context object is in an “or” relationship. In the embodiment of this disclosure, the term “multiple” refers to two or more, and other quantifiers have similar meanings.

In the following, the embodiments of the present disclosure will be clearly and completely described with reference to the accompanying drawings in the embodiments of the present disclosure. The described embodiments are only parts of the embodiments of the present disclosure, but not all of the embodiments. Based on the embodiments in this disclosure, all other embodiments belong to the scope of protection in this disclosure.

In order to expand the network coverage in the 5G NR system, UE-to-Network Relay, which is a relay from a user terminal to a network device, and UE-to-UE Relay, which is a relay from a user terminal to a user terminal, are introduced. Among them, a Relay UE (Relay UE) is a user terminal within a network coverage, and a remote user terminal can be located within or outside the network coverage. For UE-to-Network Relay, the remote user terminal can access a network device through the relay user terminal, and for UE-to-UE Relay, the remote user terminal can access another remote user terminal through the relay user terminal.

In the above scenario of UE-to-UE Relay, a bearer between two remote user terminals is referred to as an end-to-end bearer, and two PC5 RLC channels (that is, PC5 RLC channels between two remote user terminals and a relay user terminal) are required for bottom-layer transmission of an end-to-end bearer.

FIG. 1 is a schematic diagram of an application scenario provided by an embodiment of the present disclosure. It should be noted that this scenario is a communication architecture for a UE-to-UE Relay. As shown in FIG. 1, this scenario includes a first remote user terminal 101, a second remote user terminal 102 and a relay user terminal 103.

It should be noted that for the UE-to-UE relay, interfaces used between the relay user terminal 103 and the first remote user terminal 101, and between the relay user terminal 103 and the second remote user terminal 102 are all direct communication, in which direct communication refers to a way that adjacent user terminals can perform data transmission through a direct communication link (also referred to as Sidelink or PC5) in a short distance range, and the wireless interface corresponding to the Sidelink is referred to as a direct communication interface (also referred to as Sidelink interface or PC5 interface)

In one embodiment, the direct communication interface identifies the communication peer through a combination of a source L2 identity, a destination L2 identity and a transmission type. Among them, the size of the source L2 identity is 24 bits, the size of the destination L2 identity is 24 bits, and the transmission type (for example, multicast, unicast, broadcast, etc.) needs to occupy at least 2 bits. In other words, in the communication process, an identification requires at least 50 bits, and considering a whole byte problem, it needs to occupy at least 7 bytes of overhead.

In the above UE-to-UE Relay, an adaptation layer needs to perform a mapping between two direct communication links, and both of which need to use the identification of the direct communication interface carried in the adaptation layer. If the identification of 50-bits of direct communication interface is used, the overhead of 7 bytes will reduce the resource utilization rate in the end-to-end communication process, thus reducing the data transmission efficiency, which is basically unacceptable in this communication architecture.

In view of this, embodiments of the present disclosure provide an information processing method, an apparatus, a user terminal and a storage medium, in which a relay user terminal or a remote user terminal determines a first identification used between two remote user terminals for performing end-to-end data transmission by the relay user terminal, determines a second identification the number of bits of which is less than that of the first identification according to the first identification, and sends a mapping relationship between the first identification and a second identification to the two remote user terminals, and when the two remote user terminals perform end-to-end communication according to the second identification, the second identification is carried in an adaptation layer, which saves a head overhead of the adaptation layer, to improve a resource utilization rate in the end-to-end communication process and ensuring an end-to-end data transmission efficiency.

It should be noted that the above first remote user terminal 101, the second remote user terminal 102 and the relay user terminal 103 can all be devices that provide voice and/or data connectivity to users, handheld devices with wireless connection function, or other processing devices connected to wireless modems.

In addition, the names of the user terminals may vary in different systems. For example, in a 5G system, the above user terminals may be referred to as User Equipment (User Equipment, UE), and the user terminals may also be wireless user terminals, where the wireless user terminals can communicate with one or more core networks (Core networks, CN) through a radio access network (radio access network, RAN). Wireless user terminals can be mobile user terminals, such as mobile phones (or “cellular” phones) and computers with mobile user terminals, such as portable, pocket-sized, handheld, computer-built or vehicle-mounted mobile devices, which exchange voice and/or data with wireless access networks. For example, Personal Communication Service (Personal Communication Service, PCS) phones, cordless phones, Session Initiated Protocol (Session Initiated Protocol, SIP) phones, Wireless Local Loop (Wireless Local Loop, WLL) stations, Personal Digital Assistant (Personal Digital Assistant, PDA) and other devices. A wireless user terminal may also be referred to as a system, a subscriber unit (subscriber unit), a subscriber station (subscriber station), A mobile station (mobile station), a mobile (mobile), a remote station (remote station), an access point (access point), a remote user terminal (remote user terminal), an access user terminal (access user terminal), a user agent (user agent) and a user device (user device), which are not limited in this embodiment.

The embodiments of the present disclosure can be applied to various systems. For example, the applicable system can be a global system of mobile communication (global system of mobile communication, GSM) system, a code division multiple access (code division multiple access, CDMA), a wideband code division multiple access (wideband code division multiple access, WCDMA), a general packet radio service (general packet radio service, GPRS) system, a long-term evolution (long term evolution, LTE) system, a LTE frequency division duplex (frequency division duplex, FDD) system, a LTE time division duplex (LTE time division duplex, TDD) system, a long term evolution advanced (long term evolution advanced, LTE-A) system, a universal mobile telecommunication system (universal mobile telecommunication system, UMTS), a worldwide Interoperability for microwave access (worldwide Interoperability for microwave access, WiMAX) system, 5G New Radio (New Radio, NR) system, etc. These systems all include user terminals and network devices. The system also includes the core network, such as an evolved packet system (Evolved Packet System, EPS) and a 5G system (5GS), etc.

It should be understood that the above-mentioned FIG. 1 is schematic, and other network devices may be included in the above-mentioned scenario, such as wireless repeater devices and wireless backhaul devices, which are not shown in FIG. 1.

It should be noted that the method and the device provided by the embodiments of the present disclosure are based on the same application concept, and since the principles of the method and the device for solving problems are similar, the implementation of the device and the method can be referred to each other, and the repetition has been omitted here.

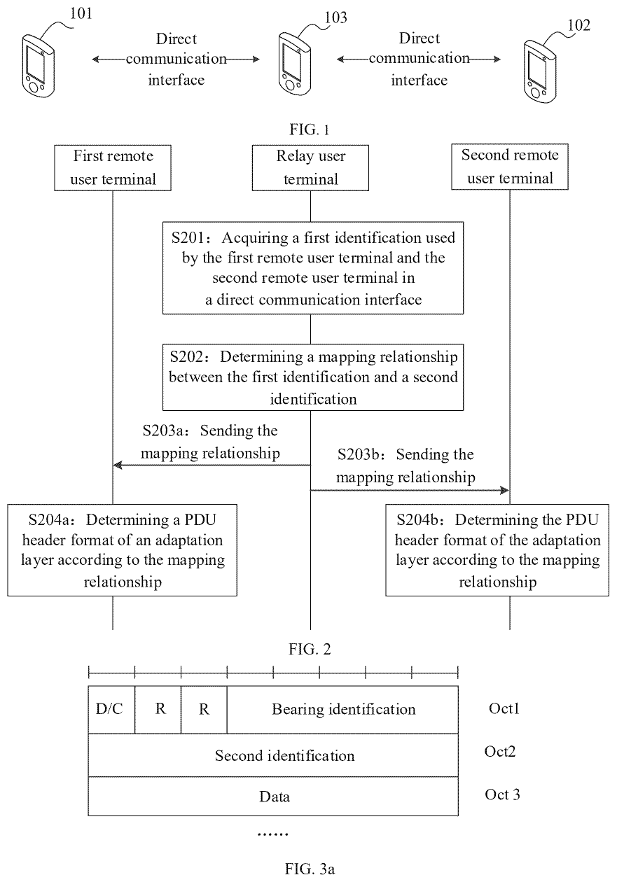

FIG. 2 is a first schematic diagram for signaling interaction of an information processing method provided by an embodiment of the present disclosure. As shown in FIG. 2, the information processing method may include the following steps:
S201: the relay user terminal acquires a first identification used by a first remote user terminal and a second remote user terminal in a direct communication interface.

The first identification includes a source L2 identity and a destination L2 identity used by the direct communication interface. In one embodiment, the first identification includes the source L2 identity, the destination L2 identity and a transmission type.

In some embodiments, before step S201, the first remote user terminal and the second remote user terminal may establish an end-to-end connection through the relay user terminal. In one embodiment, the first remote user terminal may first send a discovery (discovery) message, and after the relay user terminal receives the discovery message sent by the first remote user terminal, it adds an identification of the relay user terminal to the discovery message to obtain a target discovery message, and then forwards the target discovery message. Further, after receiving the target discovery message sent by the relay user terminal, the second remote user terminal determines the relay user terminal through the identification in the target discovery message, and establishes an end-to-end Radio Resource Control (Radio Resource Control, RRC) connection with the first remote user terminal through the relay user terminal.
S202: the relay user terminal determines a mapping relationship between the first identification and a second identification.

In the embodiment of the present disclosure, the number of bits of the second identification is less than that of the first identification, and the method for determining the second identification is shown in the subsequent embodiments.
S203a: the relay user terminal sends the mapping relationship between the first identification and the second identification to the first remote user terminal.
S203b: the relay user terminal sends the mapping relationship between the first identification and the second identification to the second remote user terminal.
S204a: the first remote user terminal determines a Protocol Data Unit (Protocol Data Unit, PDU) header format of an adaptation layer according to the mapping relationship.
S204b: the first remote user terminal determines the PDU header format of the adaptation layer according to the mapping relationship.

It should be noted that an execution order of the above steps S203a and S203b and an execution order of the above steps S204a and S204b are not particularly limited in the embodiment of the present disclosure.

Since the number of bits of the second identification is less than that of the first identification, compared with the manner of carrying the first identification in the adaptation layer in the prior art, in the embodiment of the present disclosure, when the second identification is carried in the adaptation layer during the end-to-end communication, the head overhead of the adaptation layer can be saved, and to improve a resource utilization rate when the remote user terminal performs data transmission through U2U relay and ensure an end-to-end data transmission efficiency.

It should be noted that at least one of the first remote user terminal, the second remote user terminal and the relay user terminal carries the second identification in a Packet Data Unit-header (Packet Data Unit-header, PDU-header) of the adaptation layer when performing data transmission through the direct communication interface. Accordingly, when a data receiver (including the relay device and the remote user terminal) receives the PDU header of the adaptation layer, it can determine the source L2 identity, the destination L2 identity and the transmission type in the first identification according to the second identification and the mapping relationship, and to receive or forward data according to the identification and realize the end-to-end data transmission.

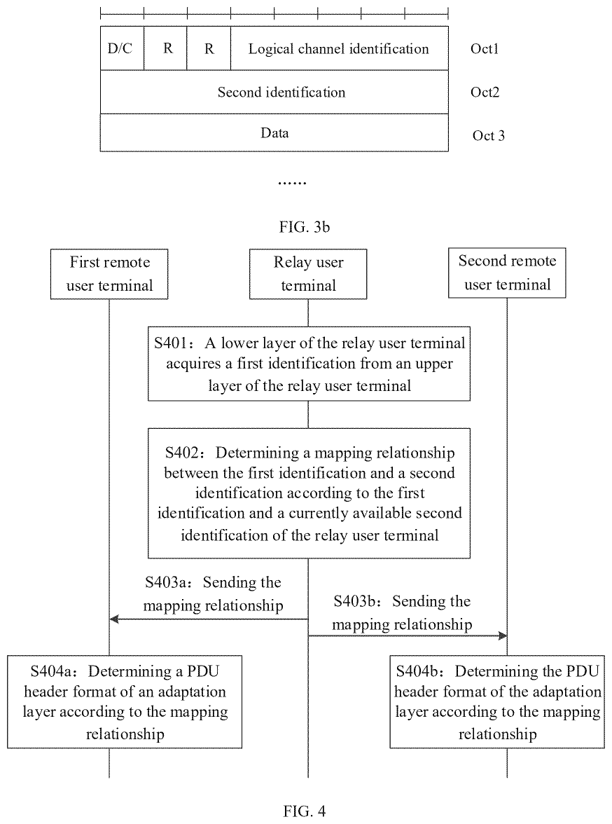

Next, with reference to FIG. 3a and FIG. 3b, an exemplary description will be given for the PDU header format of the adaptation layer used by the remote user terminal in an end-to-end communication.

Example 1: FIG. 3a is a first schematic diagram of a PDU header of the adaptation layer provided by an embodiment of the present disclosure. As shown in FIG. 3a, the protocol unit header includes the second identification and an end-to-end Bearer identification (ID) (Bearer ID) between the first remote user terminal and the second remote user terminal.

Example 2: FIG. 3b is a second schematic diagram of a PDU header of the adaptation layer provided by an embodiment of the present disclosure. As shown in FIG. 3b, the PDU header includes the second identification and an end-to-end logical channel identification (LCID) between the first remote user terminal and the second remote user terminal.

It should be noted that in FIG. 3a, the second identification is 8 bits, the Bearer ID is 5 bits, and the PDU header of the adaptation layer occupies 2 bytes. In FIG. 3b, the second identification is 8 bits, the LCID is 5 bits, and the PDU header of the adaptation layer occupies 2 bytes. Therefore, compared with the existing methods, when the second identification is carried in the adaptation layer during the end-to-end communication, the header overhead of the adaptation layer is greatly saved, to improve the resource utilization rate in the end-to-end communication process and ensuring the end-to-end data transmission efficiency.

In the first example, the first identification can be acquired by the relay user terminal, and the mapping relationship is acquired by the relay user terminal according to the first identification. Next, it will be described in detail with reference to FIG. 4.

FIG. 4 is a second schematic diagram for signaling interaction of an information processing method provided by an embodiment of the present disclosure. As shown in FIG. 4, the information processing method may include the following steps:
S401: a lower layer of a relay user terminal acquires a first identification from an upper layer of the relay user terminal.

In one embodiment, the upper layer of the relay user terminal acquires the first identification through a PC5-S signaling process, and sends first indication information carrying the first identification to the lower layer of the relay user terminal, and the lower layer of the relay user terminal acquires the first identification through the first indication information.

It should be noted that the specific types of the upper layer and the lower layer are not particularly limited in the embodiment of the present disclosure. For example, the upper layer may be a PC5-S protocol layer and the lower layer may be a PC5-RRC layer. That is, a possible example of the embodiment of the present disclosure is that the PC5-S protocol layer of the relay user terminal acquires the first identification used between the first remote user terminal and the second remote user terminal, and notifies the PC5-RRC layer of the remote user terminal.

It should be noted that for a scheme of establishing an RRC connection between the first remote user terminal and the second remote user terminal through the relay user terminal, please refer to the embodiment shown in FIG. 2, and the details of which are not repeated herein.
S402: the relay user terminal determines a mapping relationship between the first identification and a second identification according to the first identification and a currently available second identification of the relay user terminal.

In some embodiments, the relay user terminal determining the mapping relationship through the above step S402 includes the following steps:
(1) determining a currently unoccupied candidate second identification as the currently available second identification of the relay user terminal:
(2) for the first identification, selecting the second identification from the currently available second identification of the relay user terminal: and
(3) determining the mapping relationship between the first identification and the second identification according to the second identification.

It should be noted that the manner of selecting the second identification from the currently available second identification of the relay user terminal is not limited by the embodiments of the present disclosure. For example, one currently available second identification of the relay user terminal can be randomly selected as the second identification.

For example, taking the first identification including a source L2 identity identification, a destination L2 identity identification and a communication type identification, and a length of the second identification being 8 bits as an example, after receiving one piece of the first identification, the relay user terminal can randomly select one unoccupied second identification from the currently unused candidate second identification, and then determine the mapping relationship between the first identification and the second identification according to the first identification and the second identification.
S403a: the relay user terminal sends the mapping relationship between the first identification and the second identification to the first remote user terminal.

In one embodiment, the relay user terminal may send the mapping relationship to the first remote user terminal through a first PC5-RRC signaling between the relay user terminal and the first remote user terminal.
S403b: the relay user terminal sends the mapping relationship between the first identification and the second identification to the second remote user terminal.

Similarly, the relay user terminal can send the mapping relationship to the second remote user terminal through a second PC5-RRC signaling between the relay user terminal and the second remote user terminal.
S404a: the first remote user terminal determines a PDU header format of the adaptation layer according to the mapping relationship.
S404b: the second remote user terminal determines the PDU header format of the adaptation layer according to the mapping relationship.

At least one of the first remote user terminal, the second remote user terminal and the relay user terminal carries the second identification in the PDU header of the adaptation layer when performing data transmission through the direct communication interface.

It should be noted that for the PDU header format, please refer to the embodiment shown in FIG. 3, which is not repeated herein. In addition, an execution order of the above steps S403a and S403b and an execution order of the above steps S404a and S404b are not limited in the embodiment of the present disclosure.

Since the number of bits of the second identification is less than that of the first identification, compared with the manner of carrying the first identification in the adaptation layer in the prior art, in the embodiment of the present disclosure, when the second identification is carried in the adaptation layer during the end-to-end communication, the head overhead of the adaptation layer can be saved, and the resource utilization rate when the remote user terminal performs data transmission through the relay user terminal can be improved, and the end-to-end data transmission efficiency can be guaranteed. In addition, when the relay user terminal acquires the first identification, it acquires the first identification from the upper layer of the relay user terminal through the lower layer of the relay user terminal, and no intervention of the remote user terminal is needed in this process, and signaling interaction can be reduced and the implementation complexity of the present disclosure can be reduced.

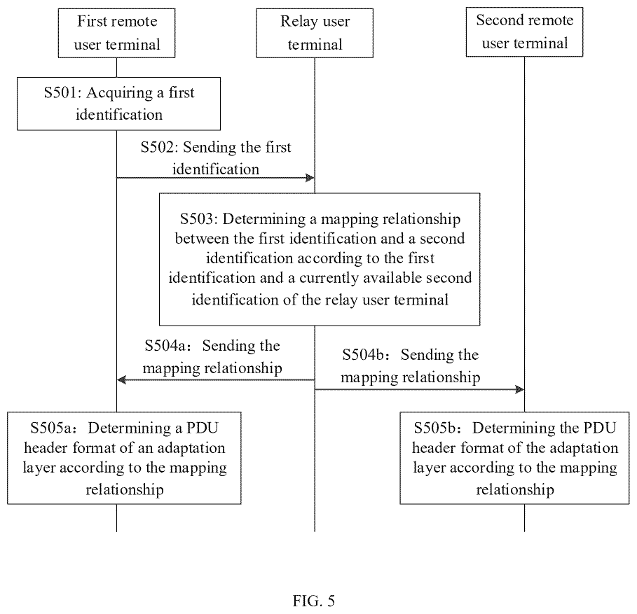

In the second example, the first identification can also be acquired by the remote user terminal, and the mapping relationship is acquired by the relay user terminal according to the first identification. Next, it will be described in detail with reference to FIG. 5.

FIG. 5 is a third schematic diagram for signaling interaction of the information processing method provided by the embodiment of the present disclosure. As shown in FIG. 5, the information processing method may include the following steps:
S501: the remote user terminal acquires a first identification.

It should be noted that for a scheme of establishing an RRC connection between the first remote user terminal and the second remote user terminal through the relay user terminal, please refer to the embodiment shown in FIG. 2, and the details of which are not repeated herein.

In some embodiments, the remote user terminal (the first remote user terminal or the second remote user terminal) acquiring the first identification includes but is not limited to the following two embodiments.
(1) An upper layer of the remote user terminal acquires the first identification through a PC5-S signaling process, and sends third indication information carrying the first identification to a lower layer of the remote user terminal, and the lower layer of the remote user terminal acquires the first identification through the third indication information.

It should be noted that the specific types of the upper layer and the lower layer of the remote user terminal are not limited in this embodiment of the present disclosure. For example, the upper layer of the remote user terminal may be the PC5-S protocol layer, and the lower layer of the remote user terminal may be the PC5-RRC layer. That is, in an example of the present disclosure, after determining by the remote user terminal, a first identification used between the first remote user terminal and the second remote user terminal, the third indication information carrying the first identification is sent to the PC5-RRC layer of the remote user terminal through the upper layer PC5-S protocol layer of the remote user terminal, and the PC5-RRC layer of the remote user terminal acquires the first identification through the third indication information.
(2) The first identification is acquired through an end-to-end PC5-RRC signaling interaction process performed by the lower layer of the first remote user terminal.
S502: the remote user terminal sends the first identification to the relay user terminal.

In one embodiment, the first remote user terminal sends the second indication information and the first identification to the relay user terminal through a first PC5-RRC signaling between the first remote user terminal and the relay user terminal.

It should be noted that the remote user terminal in the embodiment may be the first remote user terminal and/or the second remote user terminal, and the first remote user terminal is taken as an example in steps S501˜S502 in FIG. 5, but it is not limited to this. For example, the first identification can also be acquired through the second remote user terminal, and the second remote user terminal sends the second indication information and the first identification to the relay user terminal through a second PC5-RRC signaling between the second remote user terminal and the relay user terminal.

S503: the relay user terminal determines a mapping relationship between the first identification and a second identification according to the first identification and a currently available second identification of the relay user terminal.

In one embodiment, the above step S503 may include the following steps:
(1) determining a currently unoccupied candidate second identification as the currently available second identification of the relay user terminal:
(2) for the first identification, selecting the second identification from the currently available second identification of the relay user terminal: and
(3) determining the mapping relationship between the first identification and the second identification according to the second identification.

It should be noted that the implementation manner of step S503 is similar to the method and principle of step S402 in FIG. 4, which will not be repeated herein.
S504a: the relay user terminal sends the mapping relationship between the first identification and the second identification to the first remote user terminal.

Exemplary, the relay user terminal sends the mapping relationship to the first remote user terminal through a first PC5-RRC signaling between the relay user terminal and the first remote user terminal.
S504b: the relay user terminal sends the mapping relationship between the first identification and the second identification to the second remote user terminal.

In one embodiment, the relay user terminal sends the mapping relationship to the second remote user terminal through a second PC5-RRC signaling between the relay user terminal and the second remote user terminal.
S505a: the first remote user terminal determines a PDU header format of the adaptation layer according to the mapping relationship.
S505b: the second remote user terminal determines the PDU header format of the adaptation layer according to the mapping relationship.

At least one of the first remote user terminal, the second remote user terminal and the relay user terminal carries the second identification in the PDU header of the adaptation layer when performing data transmission through the direct communication interface.

It should be noted that for the PDU header format, please refer to the embodiment shown in FIG. 3, which is not repeated herein. In addition, an execution order of the above steps S504a and S504b and an execution order of the above steps S505a and S505b are not particularly limited in the embodiment of the present disclosure.

Since the number of bits of the second identification is less than that of the first identification, compared with the manner of carrying the first identification in the adaptation layer in the prior art, in the embodiment of the present disclosure, when the second identification is carried in the adaptation layer during the end-to-end communication, the head overhead of the adaptation layer can be saved, and the resource utilization rate when the remote user terminal performs data transmission through the relay user terminal can be improved, and the end-to-end data transmission efficiency can be guaranteed. In addition, the remote user terminal acquires the first identification, and the relay user terminal determines the mapping relationship according to the first identification, and the scheme can be flexibly applied to various communication scenarios.

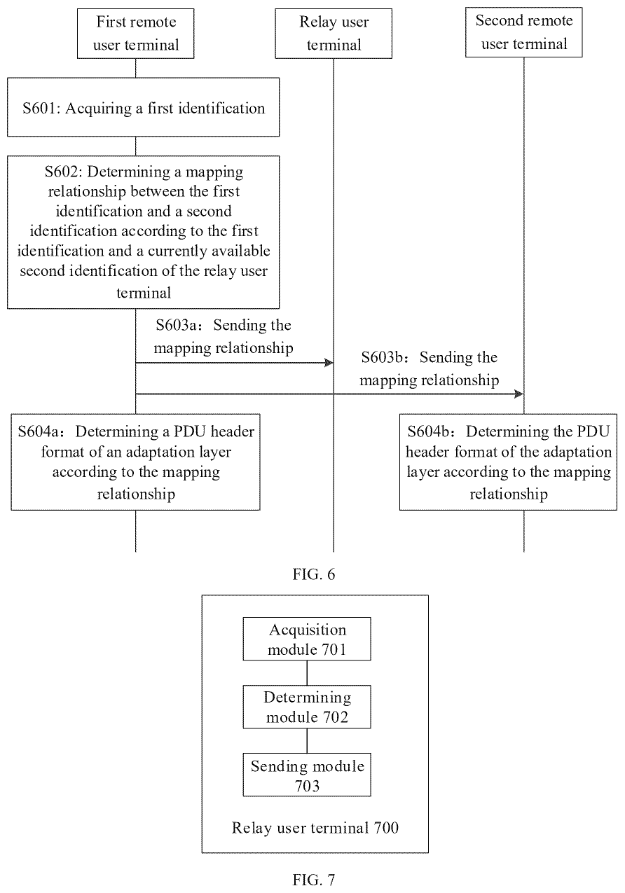

In the third example, the first identification can also be acquired by the remote user terminal, and the mapping relationship is acquired according to the first identification. Next, it will be described in detail with reference to FIG. 6:

FIG. 6 is a fourth schematic diagram for signaling interaction of the information processing method provided by an embodiment of the present disclosure. As shown in FIG. 6, the information processing method may include the following steps:
S601: the remote user terminal acquires a first identification.

It should be noted that for a scheme of establishing an RRC connection between the first remote user terminal and the second remote user terminal through the relay user terminal, please refer to the embodiment shown in FIG. 2, and the details of which are not repeated herein.

In some embodiments, the remote user terminal (the first remote user terminal or the second remote user terminal) acquiring the first identification includes but is not limited to the following two embodiments.
(1) An upper layer of the first remote user terminal acquires the first identification through a PC5-S signaling process, and sends third indication information carrying the first identification to a lower layer of the first remote user terminal, and the lower layer of the first remote user terminal acquires the first identification through the third indication information.
(2) The first identification is acquired through an end-to-end PC5-RRC signaling interaction process performed by the lower layer of the first remote user terminal.

It should be noted that the implementation manner of step S601 above is similar to the method and principle of step S501 in FIG. 5, which will not be repeated herein.
S602: the remote user terminal determines a mapping relationship between the first identification and a second identification according to the first identification and a currently available second identification of the relay user terminal.

In some embodiments, the remote device determining the mapping relationship includes the following steps:
(1) determining a currently unoccupied candidate second identification as the currently available second identification of the relay user terminal:
(2) for the first identification, selecting the second identification from the currently available second identification of the relay user terminal: and
(3) determining the mapping relationship between the first identification and the second identification according to the second identification.

S603a: the remote user terminal sends the mapping relationship between the first identification and the second identification to the relay user terminal.

In one embodiment, if the remote user terminal is the first remote user terminal, the first remote user terminal can send the mapping relationship to the relay user terminal through a first PC5-RRC signaling between the relay user terminal and the first remote user terminal. Similarly, if the remote user terminal is the second remote user terminal, the second remote user terminal can send the mapping relationship to the relay user terminal through a second PC5-RRC signaling between the relay user terminal and the second remote user terminal.
S603b: the remote user terminal sends the mapping relationship between the first identification and the second identification to another remote user terminal.

Exemplary, if the remote user terminal is the first remote user terminal, the first remote user terminal sends the mapping relationship to the second remote user terminal through a third PC5-RRC signaling between the first remote user terminal and the second remote user terminal. Similarly, if the remote user terminal is a second remote user terminal, the second remote user terminal can send the mapping relationship to the first remote user terminal through the third PC5-RRC signaling between the first remote user terminal and the second remote user terminal.

It should be noted that in the embodiment shown in FIG. 6, steps S601˜S602, and S603a and S603b all take the remote user terminal being the first remote user terminal as an example, but the practical application is not limited to this.

S604a: the first remote user terminal determines a PDU header format of the adaptation layer according to the mapping relationship.

S604b: the second remote user terminal determines the PDU header format of the adaptation layer according to the mapping relationship.

At least one of the first remote user terminal, the second remote user terminal and the relay user terminal carries the second identification in the PDU header of the adaptation layer when performing data transmission through the direct communication interface.

It should be noted that for the PDU header format, please refer to the embodiment shown in FIG. 3, which is not repeated herein. In addition, an execution order of the above steps S603a and S603b and an execution order of the above steps S604a and S604b are not limited in the embodiments of the present disclosure.

Since the number of bits of the second identification is less than that of the first identification, compared with the manner of carrying the first identification in the adaptation layer in the prior art, in the embodiment of the present disclosure, when the second identification is carried in the adaptation layer during the end-to-end communication, the head overhead of the adaptation layer can be saved, and the resource utilization rate when the remote user terminal performs data transmission through the relay user terminal is improved, and the end-to-end data transmission efficiency can be guaranteed. In addition, the remote user terminal acquires the first identification and determines the mapping relationship according to the first identification, and the scheme can be flexibly applied to various communication scenarios. For example, in the scenario where the relay user terminal cannot acquire the first identification and the mapping relationship, the first identification is acquired through the remote user terminal. Acquiring the mapping relationship according to the first identification can also achieve the purpose of reducing the header overhead of the adaptation layer in the present disclosure.

On the target relay user terminal side, an embodiment of the present disclosure provides a relay user terminal. FIG. 7 is a first structural schematic diagram of a relay user terminal provided by an embodiment of the present disclosure. As shown in FIG. 7, the relay user terminal 700 includes:
an acquisition module 701, configured to acquire a first identification used by a first remote user terminal and a second remote user terminal at a direct communication interface, where the first remote user terminal and the second remote user terminal are in end-to-end communication connection through the relay user terminal; a determining module 702, configured to determine a mapping relationship between the first identification and a second identification: and a sending module 703, configured to send the mapping relationship to the first remote user terminal and/or the second remote user terminal: where the first identification includes a source L2 identity and a destination L2 identity used by the direct communication interface, or the first identification includes the source L2 identity, the destination L2 identity and a transmission type, and the number of bits of the second identification is less than that of the first identification.

In some embodiments, the acquisition module 701 is configured to: receive the first identification sent by the first remote user terminal and/or the second remote user terminal; or acquire, by a lower layer of the relay user terminal, the first identification from an upper layer of the relay user terminal.

In some embodiments, the acquisition module 701 is configured to: receive the first identification sent by the first remote user terminal through a first PC5-RRC signaling; and/or receive the first identification sent by the second remote user terminal through a second PC5-RRC signaling.

In some embodiments, the acquisition module 701 is configured for the upper layer of the relay user terminal to acquire the first identification through a PC5-S signaling process, and send first indication information carrying the first identification to the lower layer of the relay user terminal, and the lower layer of the relay user terminal acquires the first identification through the first indication information.

In some embodiments, the acquisition module 701 is configured to: receive second indication information sent by the first remote user terminal and/or the second remote user terminal, and determine the mapping relationship between the first identification and the second identification according to the second indication information; or determine the mapping relationship between the first identification and the second identification according to the first identification and a currently available second identification of the relay user terminal.

In some embodiments, the acquisition module 701 is configured to: determine a currently unoccupied candidate second identification as the currently available second identification of the relay user terminal: and for the first identification, select the second identification from the currently available second identification of the relay user terminal; and determine the mapping relationship between the first identification and the second identification according to the second identification.

In some embodiments, the sending module 703 is configured to: send the mapping relationship to the first remote user terminal through a first PC5-RRC signaling between the relay user terminal and the first remote user terminal; and/or send the mapping relationship to the second remote user terminal through a second PC5-RRC signaling between the relay user terminal and the second remote user terminal.

In some embodiments, when the relay user terminal performs data transmission with the first remote user terminal through the direct communication interface, the second identification is carried in a PDU header of an adaptation layer: and/or when the relay user terminal performs data transmission with the second remote user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal; or a logical channel identification LCID of the end-to-end direct communication interface between the first remote user terminal and the second remote user terminal.

It should be noted here that the relay user terminal provided by the present disclosure can correspondingly realize all the method steps realized by the relay user terminal in the above method embodiments, and can achieve the same effect, so the same parts and beneficial effects between this embodiment and the method embodiment are not repeated herein.

On the remote user terminal side, the embodiments of the present disclosure provides a remote user terminal, which is a first remote user terminal or a second remote user terminal, and the first remote user terminal and the second remote user terminal are in end-to-end communication connection through a relay user terminal.

FIG. 8 is a first structural schematic diagram of a remote user terminal provided by an embodiment of the present disclosure. As shown in FIG. 8, the remote user terminal 800 includes an acquisition module 801, configured to acquire a mapping relationship between a first identification and a second identification; and a determining module 802, configured to determine a PDU header format of an adaptation layer according to the mapping relationship; where the first identification includes a source L2 identity and a destination L2 identity used by a direct communication interface, or the first identification includes the source L2 identity, the destination L2 identity and a transmission type, and the number of bits of the second identification is less than that of the first identification.

In some embodiments, the acquisition module 801 is configured to: receive the mapping relationship sent by the relay user terminal; or determine the mapping relationship according to the first identification and the second identification.

In some embodiments, the acquisition module 801 is configured to: acquire the first identification; send second indication information and the first identification to the relay user terminal through a first PC5-RRC signaling between the first remote user terminal and the relay user terminal, and receive the mapping relationship sent by the relay user terminal through the first PC5-RRC signaling; and/or send the second indication information and the first identification to the relay user terminal through a second PC5-RRC signaling between the second remote user terminal and the relay user terminal, and receive the mapping relationship sent by the relay user terminal through the second PC5-RRC signaling.

In some embodiments, the acquisition module 801 is configured to: acquire the first identification: determine the currently unoccupied candidate second identification as a currently available second identification of the relay user terminal; and for the first identification, select the second identification from the currently available second identification of the relay user terminal: and determine the mapping relationship between the first identification and the second identification according to the second identification.

In some embodiments, the acquisition module 801 is configured for an upper layer of the first remote user terminal to acquire the first identification through a PC5-S signaling process, and send third indication information carrying the first identification to a lower layer of the first remote user terminal, and the lower layer of the first remote user terminal acquires the first identification through the third indication information: or acquire the first identification through an end-to-end PC5-RRC signaling interaction process performed by the lower layer of the first remote user terminal.

In some embodiments, the remote user terminal 800 further includes: a sending module 803, configured for the first remote user terminal to send the mapping relationship to the relay user terminal through a first PC5-RRC signaling; or configured for the second remote user terminal to send the mapping relationship to the relay user terminal through a second PC5-RRC signaling: or configured for the first remote user terminal to send the mapping relationship to the second remote user terminal through an end-to-end third PC5-RRC signaling between the first remote user terminal and the second remote user terminal; or configured for the second remote user terminal to send the mapping relationship to the first remote user terminal through the third PC5-RRC signaling.

In some embodiments, where when the first remote user terminal performs data transmission through the direct communication interface, the second identification is carried in a PDU header of an adaptation layer; and/or when the second remote user terminal performs data transmission with the relay user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal: or a logical channel identification LCID of the end-to-end direct communication interface between the first remote user terminal and the second remote user terminal.

It should be noted here that the remote user terminal 800 provided by this disclosure can correspondingly realize all the method steps realized by the first remote user terminal or the second remote user terminal in the above method embodiment, and can achieve the same effect, therefore, same parts as those in the method embodiments and beneficial effects in this embodiment are not repeated herein.

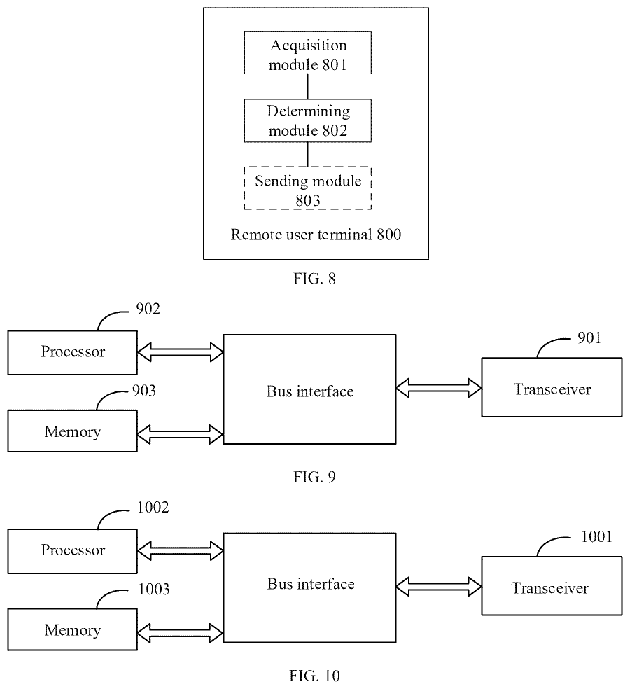

FIG. 9 is a second schematic structural diagram of a relay user terminal provided by an embodiment of the present disclosure. As shown in FIG. 9, the relay user terminal includes a transceiver 901, a processor 902 and a memory 903.

The memory 903 is configured to store a computer program.

The transceiver 901 is configured to receive and send data under control of a processor 902.

In FIG. 9, the bus architecture can include any number of interconnected buses and bridges. In one embodiment, one or more processors represented by the processor 902 and various circuits of a memory represented by the memory 903 are linked together. The bus architecture can also link various other circuits, such as peripheral devices, voltage regulators and power management circuits, which are well known in the field, and will not be further described here. The bus interface provides the interface. The transceiver 901 can be multiple elements, that is, it includes a transmitter and a receiver, and provides a unit for communicating with various other devices on a transmission media, such as wireless channels, wired channels, optical cables and the like. The processor 902 is responsible for managing the bus architecture and general processing, and the memory 903 can store data used by the processor 902 when performing operations.

The processor 902 is responsible for managing the bus architecture and general processing, and the memory 903 can store data used by the processor 902 when performing operations. In some embodiments, the processor 902 may be a central processing unit (central processing unit, CPU), an application specific integrated circuit (application specific integrated circuit, ASIC), a Field-Programmable Gate Array (Field-Programmable Gate Array, FPGA), or complex programmable logic device (complex programmable logic device, CPLD), and the processor can also adopt a multi-core architecture.

By calling the computer program stored in the memory 903, the processor 902 is configured to perform any user terminal access method related to the target relay user terminal provided by the embodiments of the present disclosure according to the obtained executable instructions. The processor 902 and the memory 903 may also be physically separated.

In one embodiment, the processor 902 is configured to read the computer program in the memory 903 and perform the following operations: acquiring a first identification used by a first remote user terminal and a second remote user terminal at a direct communication interface, where the first remote user terminal and the second remote user terminal are in end-to-end communication connection through the relay user terminal: determining a mapping relationship between the first identification and a second identification: and sending the mapping relationship to the first remote user terminal and/or the second remote user terminal: where the first identification includes a source L2 identity and a destination L2 identity used by the direct communication interface, or the first identification includes the source L2 identity, the destination L2 identity and a transmission type, and the number of bits of the second identification is less than that of the first identification.

In some embodiments, the processor 902 is further configured to perform at least one of the following operations: receiving the first identification sent by the first remote user terminal and/or the second remote user terminal: or acquiring, by a lower layer of the relay user terminal, the first identification from an upper layer of the relay user terminal.

In some embodiments, the processor 902 is further configured to perform the following operations: receiving the first identification sent by the first remote user terminal through a first PC5-RRC signaling: and/or receiving the first identification sent by the second remote user terminal through a second PC5-RRC signaling.

In some embodiments, the processor 902 is further configured to perform the following operations: acquiring, by the upper layer of the relay user terminal, the first identification through a PC5-S signaling process, and sending first indication information carrying the first identification to the lower layer of the relay user terminal, and the lower layer of the relay user terminal acquires the first identification through the first indication information.

In some embodiments, the processor 902 is further configured to perform at least one of the following operations: receiving second indication information sent by the first remote user terminal and/or the second remote user terminal, and determining the mapping relationship between the first identification and the second identification according to the second indication information: or determining the mapping relationship between the first identification and the second identification according to the first identification and a currently available second identification of the relay user terminal.

In some embodiments, the processor 902 is further configured to perform the following operations: determining a currently unoccupied candidate second identification as the currently available second identification of the relay user terminal: and for the first identification, selecting the second identification from the currently available second identification of the relay user terminal: and determining the mapping relationship between the first identification and the second identification according to the second identification. In some embodiments, the processor 902 is further configured to perform the

following operations: sending the mapping relationship to the first remote user terminal through a first PC5-RRC signaling between the relay user terminal and the first remote user terminal: and/or sending the mapping relationship to the second remote user terminal through a second PC5-RRC signaling between the relay user terminal and the second remote user terminal.

In some embodiments, when the relay user terminal performs data transmission with the first remote user terminal through the direct communication interface, the second identification is carried in a PDU header of an adaptation layer: and/or when the relay user terminal performs data transmission with the second remote user terminal through the direct communication interface, the second identification is carried in the PDU header of the adaptation layer.

In some embodiments, the PDU header of the adaptation layer further includes at least one of the following: a bearer identification of an end-to-end direct communication interface between the first remote user terminal and the second remote user terminal: or a logical channel identification LCID of the end-to-end direct communication interface between the first remote user terminal and the second remote user terminal.

It should be noted here that the relay user terminal provided by this disclosure can realize all the method steps realized by the relay user terminal side in the above method embodiment, and can achieve the same effects, therefore, same parts as those in the method embodiments and beneficial effects in this embodiment are not repeated herein.

FIG. 10 is a second structural diagram of a remote user terminal provided by an embodiment of the present disclosure. As shown in FIG. 10, the remote user terminal is a first remote user terminal or a second remote user terminal, and the first remote user terminal and the second remote user terminal are in end-to-end communication connection through a relay user terminal. The remote user terminal includes a transceiver 1001, a processor 1002 and a memory 1003.

The memory 1003 is configured to store a computer program.

The transceiver 1001 is configured to receive and send data under control of a processor 1002.

In FIG. 10, the bus architecture can include any number of interconnected buses and bridges. In one embodiment, one or more processors represented by the processor 1002 and various circuits of a memory represented by the memory 1003 are linked together. The bus architecture can also link various other circuits, such as peripheral devices, voltage regulators and power management circuits, which are well known in the field, and will not be further described here. The bus interface provides the interface. The transceiver 1001 can be multiple elements, that is, it includes a transmitter and a receiver, and provides a unit for communicating with various other devices on a transmission media, such as wireless channels, wired channels, optical cables and the like. The processor 1002 is responsible for managing the bus architecture and general processing, and the memory 1003 can store data used by the processor 1002 when performing operations.

The processor 1002 is responsible for managing the bus architecture and general processing, and the memory 1003 can store data used by the processor 1002 when performing operations. In some embodiments, the processor 1002 may be a central processing unit (central processing unit, CPU), an application specific integrated circuit (application specific integrated circuit, ASIC), a Field-Programmable Gate Array (Field-Programmable Gate Array, FPGA), or complex programmable logic device (complex programmable logic device, CPLD), and the processor can also adopt a multi-core architecture.

By calling the computer program stored in the memory 1003, the processor 1002 is configured to perform any user terminal access method related to the target relay user terminal provided by the embodiments of the present disclosure according to the obtained executable instructions. The processor 1002 and the memory 1003 may also be physically separated.

In one embodiment, the processor 1002 is configured to read the computer program in the memory 1003 and perform the following operations: acquiring a mapping relationship between a first identification and a second identification: determining a PDU header format of an adaptation layer according to the mapping relationship: where the first identification includes a source L2 identity and a destination L2 identity used by a direct communication interface, or the first identification includes the source L2 identity, the destination L2 identity and a transmission type, and the number of bits of the second identification is less than that of the first identification.

In some embodiments, the processor 1002 is further configured to perform at least one of the following operations: receiving the mapping relationship sent by the relay user terminal: or determining the mapping relationship according to the first identification and the second identification.

In some embodiments, the processor 1002 is further configured to perform the following operations: acquiring the first identification: and sending second indication information and the first identification to the relay user terminal through a first PC5-RRC signaling between the first remote user terminal and the relay user terminal, and receiving the mapping relationship sent by the relay user terminal through the first PC5-RRC signaling: and/or sending the second indication information and the first identification to the relay user terminal through a second PC5-RRC signaling between the second remote user terminal and the relay user terminal, and receiving the mapping relationship sent by the relay user terminal through the second PC5-RRC signaling.

In some embodiments, the processor 1002 is further configured to perform the following operations: acquiring the first identification: determining a currently unoccupied candidate second identification as a currently available second identification of the relay user terminal: for the first identification, selecting the second identification from the currently available second identification of the relay user terminal: and determining the mapping relationship between the first identification and the second identification according to the second identification.

In some embodiments, the processor 1002 is further configured to perform at least one of the following operations: acquiring, by an upper layer of the first remote user terminal, the first identification through a PC5-S signaling process, and sending third indication information carrying the first identification to a lower layer of the first remote user terminal, and the lower layer of the first remote user terminal acquires the first identification through the third indication information: or acquiring the first identification through an end-to-end PC5-RRC signaling interaction process performed by the lower layer of the first remote user terminal.

In some embodiments, the processor 1002 is further configured to perform at least one of the following operations: sending, by the first remote user terminal, the mapping relationship to the relay user terminal through a first PC5-RRC signaling: or sending, by the second remote user terminal, the mapping relationship to the relay user terminal through a second PC5-RRC signaling: or sending, by the first remote user terminal, the mapping relationship to the second remote user terminal through an end-to-end third PC5-RRC signaling between the first remote user terminal and the second remote user terminal: or sending, by the second remote user terminal, the mapping relationship to the first remote user terminal through the third PC5-RRC signaling.

In some embodiments, when the first remote user terminal performs data transmission through the direct communication interface, the second identification is carried in a PDU header of an adaptation layer: and/or when the second remote user terminal performs data transmission with the relay user terminal through the direct communication interface, the second identification is carried in the PDU header of the adaptation layer.

In some embodiments, the PDU header of the adaptation layer of the relay user terminal further includes at least one of the following: a bearer identification of an end-to-end direct communication interface between the first remote user terminal and the second remote user terminal: or a logical channel identification LCID of the end-to-end direct communication interface between the first remote user terminal and the second remote user terminal.

It should be noted here that the above-mentioned remote user terminal provided by this disclosure can realize all the method steps realized by the first remote user terminal or the second remote user terminal in the above-mentioned method embodiment, and can achieve the same effect, therefore, same parts as those in the method embodiments and beneficial effects in this embodiment are not repeated herein.

It should be noted that the division of units in the embodiments of this disclosure is schematic, which is only a logical function division, and there may be another division manners in actual implementation. In addition, each functional unit in each embodiment of the present disclosure may be integrated into one processing unit, or each unit may exist physically alone, or two or more units may be integrated into one unit. The above integrated units can be realized in the form of hardware or software functional units.

If the above integrated units are realized in the form of software functional units and sold or used as independent products, they can be stored in a processor-readable storage medium. Based on this understanding, the embodiments of the present disclosure can be embodied in the form of software product in essence or in the part that has contributed to the prior art or in whole or in part of the embodiments, and the computer software product is stored in a storage medium and includes several instructions to make a computer device (which can be a personal computer, a server, a network device, etc.) or a processor (processor) execute all or part of the steps of the methods of various embodiments of the present disclosure. The aforementioned storage media include: U disk, mobile hard disk, Read-Only Memory (Read-Only Memory, ROM), Random Access Memory (Random Access Memory, RAM), magnetic disk or optical disk and other media that can store program codes.

On the relay user terminal side, an embodiment of the present disclosure provides a processor-readable storage medium, and the processor-readable storage medium stores a computer program, which is configured to enable the processor to realize all the method steps realized by the relay user terminal in the above method embodiments, and achieve the same effect, therefore, same parts as those in the method embodiments and beneficial effects in this embodiment are not repeated herein.

On the user terminal side, an embodiment of the present disclosure provides a processor-readable storage medium, and the processor-readable storage medium stores a computer program, which is configured to enable the processor to realize all the method steps realized by the remote user terminal side in the above-mentioned method embodiments, and can achieve the same effect, therefore, same parts as those in the method embodiments and beneficial effects in this embodiment are not repeated herein. The processor-readable storage medium can be any available medium or data storage device that the processor can access, including but not limited to magnetic memory (such as floppy disk, hard disk, magnetic tape, magneto-optical disk (MO), etc.), optical memory (such as CD, DVD, BD, HVD, etc.), and semiconductor memory (such as ROM, EPROM, EEPROM, non-volatile memory (NAND FLASH), solid state disk (SSD), and so on.

On the relay user terminal side, an embodiment of the present disclosure also provides a computer program product containing instructions. A computer program is stored in a storage medium, and at least one processor can read the computer program from the storage medium. When the computer program is executed by at least one processor, all the method steps realized by the relay user terminal in the above method embodiments can be realized, and the same effects can be achieved. Therefore, same parts as those in the method embodiments and beneficial effects in this embodiment are not repeated herein. On the remote user terminal side, an embodiment of the present disclosure also provides a computer program product containing instructions. A computer program is stored in a storage medium, and at least one processor can read the computer program from the storage medium. When at least one processor executes the computer program, all the method steps realized by the remote user terminal in the above method embodiments can be realized, and the same effects can be achieved. Therefore, same parts as those in the method embodiments and beneficial effects in this embodiment are not repeated herein.

An embodiment of the present disclosure also provides a communication system, which includes a relay user terminal, a first remote user terminal and a second remote user terminal. The relay user terminal can perform all the method steps performed by the relay user terminal side in the above method embodiments, and can achieve the same effect. The first remote user terminal and the second remote user terminal can perform all the method steps performed by the remote user terminal side in the above method embodiments, and can achieve the same effect. Therefore, same parts as those in the method embodiments and beneficial effects in this embodiment are not repeated herein.

Embodiments of the present disclosure may be provided as a method, a system, or a computer program product. Therefore, the present disclosure can take the form of an entirely hardware embodiment, an entirely software embodiment, or an embodiment combining software and hardware aspects. Moreover, the present disclosure may take the form of a computer program product implemented on one or more computer usable storage media (including but not limited to magnetic disk storage and optical storage, etc.) containing computer usable program codes therein.

The present disclosure is described with reference to schematic and/or block diagrams of signaling interaction of methods, devices, and computer program products according to embodiments of the present disclosure. It should be understood that each flow and/or block in the signaling interaction diagram and/or block diagram, and the combination of the flow and/or block in the signaling interaction diagram and/or block diagram can be realized by computer-executable instructions. These computer-executable instructions may be provided to a processor of a general-purpose computer, a special-purpose computer, an embedded processor or other programmable data processing apparatus to produce a machine, and the instructions executed by the processor of the computer or other programmable data processing apparatus produce means for implementing the functions specified in one or more flows of the signaling interaction diagram and/or one or more blocks of the block diagram.

These processor-executable instructions may also be stored in a processor-readable memory that can direct a computer or other programmable data processing apparatus to operate in a specific manner, and the instructions stored in the processor-readable memory produce an article of manufacture including instruction means that implement the functions specified in one or more flows of the signaling interaction diagram and/or one or more blocks of the block diagram.

These processor-executable instructions can also be loaded onto a computer or other programmable data processing device, and a series of operational steps are performed on the computer or other programmable device to produce computer-implemented processes, and the instructions executed on the computer or other programmable device provide steps for implementing the functions specified in one or more flows of the signaling interaction diagram and/or one or more blocks of the block diagram.

Various modifications and variations to the present disclosure without departing from the embodiments. Thus, if these modifications and variations of the present disclosure are within the embodiments of the claims of the present disclosure and their equivalents, the present disclosure is also intended to include these modifications and variations.

1. An information processing method, applied to a relay user terminal, wherein the information processing method comprises:
acquiring a first identification used by a first remote user terminal and a second remote user terminal at a direct communication interface, wherein the first remote user terminal and the second remote user terminal are in end-to-end communication connection through the relay user terminal;
determining a mapping relationship between the first identification and a second identification; and
sending the mapping relationship to at least one of the first remote user terminal or the second remote user terminal; wherein the first identification comprises a source L2 identity and a destination L2 identity used by the direct communication interface, or the first identification comprises the source L2identity, the destination L2 identity and a transmission type, and a number of bits of the second identification is less than that of the first identification.

2. The information processing method according to claim 1, wherein the acquiring the first identification used by the first remote user terminal and the second remote user terminal at the direct communication interface comprises: receiving the first identification sent by at least one of the first remote user terminal or the second remote user terminal; or acquiring, by a lower layer of the relay user terminal, the first identification from an upper layer of the relay user terminal.

3-4. (canceled)

5. The information processing method according to claim 1, wherein the determining the mapping relationship between the first identification and the second identification comprises: receiving second indication information sent by at least one of the first remote user terminal or the second remote user terminal, and determining the mapping relationship between the first identification and the second identification according to the second indication information; or determining the mapping relationship between the first identification and the second identification according to the first identification and a currently available second identification of the relay user terminal;
wherein the determining the mapping relationship between the first identification and the second identification according to the first identification and the currently available second identification of the relay user terminal comprises: determining a currently unoccupied candidate second identification as the currently available second identification of the relay user terminal; and for the first identification, selecting the second identification from the currently available second identification of the relay user terminal; and determining the mapping relationship between the first identification and the second identification according to the second identification.

6. (canceled)

7. The information processing method according to claim 1, wherein the sending the mapping relationship between the first identification and the second identification to at least one of the first remote user terminal or the second remote user terminal comprises at least one of the following operations: sending the mapping relationship to the first remote user terminal through a first PC5-RRC signaling between the relay user terminal and the first remote user terminal; or sending the mapping relationship to the second remote user terminal through a second PC5-RRC signaling between the relay user terminal and the second remote user terminal.

8. The information processing method according to claim 1, wherein in a condition that the relay user terminal performs data transmission with the first remote user terminal through the direct communication interface, the second identification information is carried in a protocol data unit (PDU) header of an adaptation layer; or in a condition that the relay user terminal performs data transmission with the second remote user terminal through the direct communication interface, the second identification is carried in the PDU header of the adaptation layer.

9. The information processing method according to claim 8, wherein the PDU header of the adaptation layer further comprises at least one of the following: a bearer identification of an end-to-end direct communication interface between the first remote user terminal and the second remote user terminal; or a logical channel identification (LCID) of the end-to-end direct communication interface between the first remote user terminal and the second remote user terminal.

10. An information processing method, applied to a first remote user terminal or a second remote user terminal, wherein the first remote user terminal is in end-to-end communication connection with the second remote user terminal through a relay user terminal, the information processing method comprises:
acquiring a mapping relationship between a first identification and a second identification; determining a protocol data unit (PDU) header format of an adaptation layer according to the mapping relationship; wherein the first identification comprises a source L2 identity and a destination L2 identity used by a direct communication interface, or the first identification-information comprises the source L2 identity, the destination L2 identity and a transmission type, and the number of bits of the second identification is less than that of the first identification.

11. The information processing method according to claim 10, wherein the acquiring the mapping relationship between the first identification and the second identification comprises: receiving the mapping relationship sent by the relay user terminal; or determining the mapping relationship according to the first identification and the second identification.

12. The information processing method according to claim 11, wherein the receiving the mapping relationship sent by the relay user terminal comprises: acquiring the first identification; and at least one of the following operations:
sending second indication information and the first identification to the relay user terminal through a first direct communication interface radio resource control (PC5-RRC) signaling between the first remote user terminal and the relay user terminal, and receiving the mapping relationship sent by the relay user terminal through the first PC5-RRC signaling;
or sending the second indication information and the first identification to the relay user terminal through a second PC5-RRC signaling between the second remote user terminal and the relay user terminal, and receiving the mapping relationship sent by the relay user terminal through the second PC5-RRC signaling.

13. The information processing method according to claim 11, wherein the determining the mapping relationship according to the first identification and the second identification comprises: acquiring the first identification; and
determining a currently unoccupied candidate second identification as a currently available second identification of the relay user terminal; and for the first identification, selecting the second identification from the currently available second identification of the relay user terminal; determining the mapping relationship between the first identification and the second identification according to the second identification.

14. The information processing method according to claim 12, wherein the acquiring the first identification comprises:
acquiring, by an upper layer of the first remote user terminal, the first identification through a ProSe communication-signalling (PC5-S) signaling process, and sending third indication information carrying the first identification to a lower layer of the first remote user terminal, and the lower layer of the first remote user terminal acquires the first identification through the third indication information; or acquiring the first identification through an end-to-end PC5-RRC signaling interaction process performed by the lower layer of the first remote user terminal.

15. The information processing method according to claim 13, further comprising at least one of the following operations:
sending, by the first remote user terminal, the mapping relationship to the relay user terminal through a first PC5-RRC signaling; or sending, by the second remote user terminal, the mapping relationship to the relay user terminal through a second PC5-RRC signaling; or sending, by the first remote user terminal, the mapping relationship to the second remote user terminal through an end-to-end third PC5-RRC signaling between the first remote user terminal and the second remote user terminal; or sending, by the second remote user terminal, the mapping relationship to the first remote user terminal through the third PC5-RRC signaling.

16. The information processing method according to claim 10, wherein in a condition that the first remote user terminal performs data transmission through the direct communication interface, the second identification is carried in a protocol data unit (PDU) header of an adaptation layer; or in a condition that the second remote user terminal performs data transmission with the relay user terminal through the direct communication interface, the second identification is carried in the PDU header of the adaptation layer.

17. The information processing method according to claim 16, wherein the PDU header of the adaptation layer further comprises at least one of the following: a bearer identification of an end-to-end direct communication interface between the first remote user terminal and the second remote user terminal; or a logical channel identification (LCID) of the end-to-end direct communication interface between the first remote user terminal and the second remote user terminal.

18-23. (canceled)

24. A relay user terminal, comprising:
a memory, configured to store a computer program;
a transceiver, configured to receive and send data under control of a processor;
the processor, configured to read the computer program in the memory and perform the following operations: acquiring a first identification used by a first remote user terminal and a second remote user terminal at a direct communication interface, wherein the first remote user terminal and the second remote user terminal are in end-to-end communication connection through the relay user terminal; determining a mapping relationship between the first identification and a second identification; and sending the mapping relationship to at least one of the first remote user terminal or the second remote user terminal; wherein the first identification comprises a source L2 identity and a destination L2 identity used by the direct communication interface, or the first identification comprises the source L2 identity, the destination L2 identity and a transmission type, and the number of bits of the second identification is less than that of the first identification.

25-27. (canceled)

28. The relay user terminal according to claim 24, wherein the processor is configured to perform the following operations: receiving second indication information sent by at least one of the first remote user terminal or the second remote user terminal, and determining the mapping relationship between the first identification and the second identification according to the second indication information; or determining the mapping relationship between the first identification and the second identification information according to the first identification and a currently available second identification of the relay user terminal.

29. (canceled)

30. The relay user terminal according to claim 24, wherein the processor is configured to perform at least one of the following operations: sending the mapping relationship to the first remote user terminal through a first PC5-RRC signaling between the relay user terminal and the first remote user terminal; or sending the mapping relationship to the second remote user terminal through a second PC5-RRC signaling between the relay user terminal and the second remote user terminal.

31. The relay user terminal according to claim 24, wherein in a condition that the relay user terminal performs data transmission with the first remote user terminal through the direct communication interface, the second identification is carried in a protocol data unit (PDU) header of an adaptation layer; or in a condition that the relay user terminal performs data transmission with the second remote user terminal through the direct communication interface, the second identification is carried in the PDU header of the adaptation layer.

32. The relay terminal according to claim 31, wherein the PDU header of the adaptation layer further comprises at least one of the following: a bearer identification of an end-to-end direct communication interface between the first remote user terminal and the second remote user terminal; or a logical channel identification (LCID) of the end-to-end direct communication interface between the first remote user terminal and the second remote user terminal.

33. A remote user terminal, wherein the remote user terminal is a first remote user terminal or a second remote user terminal, and the first remote user terminal is in end-to-end communication connection with the second remote user terminal through a relay user terminal, the remote user terminal comprises:
a memory, configured to store a computer program;
a transceiver, configured to receive and send data under control of a processor;
the processor, configured to read the computer program in the memory and perform the following operations of the information processing method according to claim 10.

34-41. (canceled)
